(19) United States
(12) Patent Application Publication
(10) Pub. No.: US 2020/0024551 A1
(43) Pub. Date: Jan. 23, 2020

(54) Detergents And Cleaning Products Including A Polymer Active Ingredient

(71) Applicants: Henkel AG & Co. KGaA, Duesseldorf (DE); Fraunhofer Gesellschaft zur Foerderung der angewandten Forschung e.V., Muenchen (DE)

(72) Inventors: Hendrik Hellmuth, Darmstadt (DE); Benoit Luneau, Ratingen (DE); Nicole Bode, Duesseldorf (DE); Alexander Schulz, Duesseldorf (DE); Andreas Buhl, Langenfeld (DE); Sylvia Aust, Hilden (DE); Yvonne Willemsen, Korschenbroich (DE); Andre Laschewsky, Potsdam (DE); Erik Wischerhoff, Potsdam (DE); Michael Paech, Potsdam (DE)

(73) Assignees: Henkel AG & Co. KGaA, Duesseldorf (DE); Fraunhofer Gesellschaft zur Foerderung der angewandten Forschung e.V., Muenchen (DE)

(21) Appl. No.: 16/586,104

(22) Filed: Sep. 27, 2019

Related U.S. Application Data
(62) Division of application No. 15/614,385, filed on Jun. 5, 2017, now abandoned.
Application No. 15/614,385 is a continuation of application No. PCT/EP2015/077420, filed on Nov. 24, 2015.

(30) Foreign Application Priority Data
Dec. 5, 2014 (DE) 102014017962.1

(51) Int. Cl. C11D 3/37; D06M 15/285; C11D 1/22

(52) U.S. Cl. CPC C11D 3/3769; D06M 15/285; C11D 3/3796; C11D 1/22; C11D 3/3719

(57) ABSTRACT

The aim of the invention is to improve the method for washing textiles by improving the primary detergent power of detergents and cleaning products, in particular with respect to soiling containing oil and/or grease. For this purpose, polymers having N,N-diallylamine-derived sulfobetaine units are incorporated into the products.

### FIELD OF THE INVENTION

The present invention generally relates to the use of specific polymers containing sulfobetaine units for enhancing the primary detergency of detergents or cleaning products during the washing of textiles or the cleaning of hard surfaces from in particular oily and/or greasy stains, and to detergents and cleaning products containing polymers of this kind.

### BACKGROUND OF THE INVENTION

In addition to ingredients essential for the washing process, such as surfactants and builder materials, detergents generally contain further components that can be grouped together under the term of washing auxiliaries and thus comprise various groups of active substances, such as foam regulators, graying inhibitors, bleaching agents, bleach activators, and color transfer inhibitors. Aids of this kind also include substances whose presence enhances the detergency of surfactants, without the need in general for these substances themselves to have a pronounced surfactant behavior. This also applies similarly to cleaning products for hard surfaces. Such substances are often referred to as detergency boosters or because of their pronounced effect on oil- or fat-based stains as “fat boosters.”

Detergents or rinse agents that contain, apart from the surfactant, copolymers of anionic and cationic monomers and optionally in addition nonionic monomers, are known from international patent application WO 0157171 A1.

The color- and shape-retaining action of cationically charged polymers during the washing of textiles is known from international patent application WO 0056849 A1.

The soil-release action of block copolymers of ethylenically unsaturated monomers and alkylene oxides, alkylene glycols, or cyclic ethers is known from international patent application WO 03054044 A2.

International patent application WO 03066791 A1 describes polymers associated with substrate surfaces and consisting of at least 1 mol % of amide-group-containing monomers.

Furthermore, other desirable features and characteristics of the present invention will become apparent from the subsequent detailed description of the invention and the appended claims, taken in conjunction with this background of the invention.

### BRIEF SUMMARY OF THE INVENTION

The subject of the invention is the use of polymers obtainable from the monomers N,N-diallyl-N—C₁₋₁₂-alkyl-ammonio-N—C₁₋₄-alkyl sulfonate and N-vinyl-2-pyrrolidone for enhancing the primary detergency of detergents or cleaning products during the washing of textiles or cleaning of hard surfaces from in particular oily and/or greasy stains.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

It was found surprisingly that polymers with sulfobetaine groups, derived from N,N-diallylamine, have especially good primary detergency-enhancing properties.

The polymers essential to the invention are obtainable by free-radical copolymerization of N,N-diallyl-N—C₁₋₁₂-alkyl-ammonio-N—C₁₋₄-alkyl sulfonates with N-vinyl-2-pyrrolidone, which can be carried out as block or preferably random copolymerization. They have no other units apart from the units originating from the cited monomers, but units originating from the free radical initiator can be present at the polymer ends due to production conditions. The methyl group and the ethyl group are preferred among the C₁₋₁₂ alkyl groups in the N,N-diallyl-N—C₁₋₁₂-alkyl-ammonio-N—C₁₋₄-alkyl sulfonates. The ethyl group and the propyl group are preferred among the C₁₋₄ alkyl groups in the N,N-diallyl-N—C₁₋₁₂-alkyl-ammonio-N—C₁₋₄-alkyl sulfonates, the propyl group preferably being bound at C3 to the nitrogen atom and carrying the sulfonate group at C1.

In the polymerization, N,N-diallyl-N—C₁₋₁₂-alkyl-ammonio-N—C₁₋₄-alkyl sulfonate and N-vinyl-2-pyrrolidone are preferably used in weight ratios in the range of 1:99 to 99:1, in particular of 50:50 to 20:80, so that the units originating from these monomers are also present in the stated weight ratios in the polymer essential to the invention. The polymeric active substance preferably has an average molecular weight in the range of 1000 g/mol to 300,000 g/mol, particularly of 2000 g/mol to 200,000 g/mol (here and below, the average molecular weights refer to number averages).

If a polymer essential to the invention is introduced into water together with linear alkylbenzene sulfonate, an increase in the surface tension is observed in the range of the critical micelle formation concentration (of about 0.1 g/L) in the presence of the polymer in comparison with the same concentration of the surfactant in the absence of the polymer. Without wishing to be bound to this theory, this allows the assumption that in the presence of the polymer due to the formation of a surfactant-polymer aggregate with cleaning activity, more surfactant is present in the solution and therefore less surfactant at the water-air interface and thereby the surface tension increases. A further subject of the invention, therefore, is the use of a combination of a polymer obtainable from the monomers N,N-diallyl-N—C₁₋₁₂-alkyl-ammonio-N—C₁₋₄ alkyl sulfonate and N-vinyl-2-pyrrolidone and alkylbenzene sulfonate with linear C₇₋₁₅ alkyl groups, in particular linear C₉₋₁₃ alkyl groups, for enhancing the primary detergency of detergents or cleaning products during the washing of textiles or cleaning of hard surfaces from in particular oily and/or greasy stains. The alkylbenzene sulfonates have counterions from the group of alkali metal ions and/or ammonium ions; sodium, potassium, NH₄⁺, and/or N(R¹)₄⁺ ions with R¹=hydrogen, C₁₋₄ alkyl, and/or C₂₋₄ hydroxyalkyl are preferred. In these combinations, the weight ratio of linear alkylbenzene sulfonate to the polymer essential to the invention is preferably in the range of 20:1 to 1:1, in particular of 8:1 to 3:1.

The use of the active substance employed according to the invention leads to a significantly better release of in particular greasy and cosmetic stains on hard surfaces and on textiles, also those made of cotton or with a proportion of cotton, as is the case with the use of compounds known thus far for this purpose. Alternatively, significant amounts of surfactants can be economized while the grease removal capability remains unchanged.

The use of the invention can occur in the context of a washing or cleaning process such that the polymer essential to the invention is added to a detergent- or cleaning product-containing aqueous bath or it is preferably introduced into the bath as a component of a detergent or cleaning product, the concentration of the active substance in the bath being preferably in the range of 0.01 g/L to 0.5 g/L, particularly of 0.02 g/L to 0.2 g/L.

A further subject of the invention is a method for removing in particular oily and/or greasy stains from textiles or hard surfaces by contacting the textile or the hard surface with an aqueous bath, in which a detergent or cleaning product and an aforementioned polymeric active substance are used. Said method can be carried out manually or by machine, for example, with the use of a domestic washing machine or dishwasher. It is possible in this regard to use the particularly liquid detergent or cleaning product and the active substance simultaneously or one after another. The simultaneous use can be carried out especially advantageously by the use of an agent containing the active substance.

A further subject of the invention, therefore, is a detergent or cleaning product, containing a polymer obtainable from the monomers N,N-diallyl-N—C₁₋₁₂-alkyl-ammonio-N—C₁₋₄-alkyl sulfonate and N-vinyl-2-pyrrolidone.

Detergents or cleaning products that contain an active substance to be used according to the invention or are used together with it or are used in the method of the invention, can contain all other conventional ingredients of such agents, which do not interact in an undesirable manner with the active substance essential to the invention. Preferably, a polymeric active substance as defined above is incorporated into detergents or cleaning products in amounts of 0.1% by weight to 10% by weight, in particular 0.5% by weight to 2% by weight.

A product, which contains an active substance to be used according to the invention or is used together with it or is used in the method of the invention, preferably contains a synthetic anionic surfactant of the sulfate and/or sulfonate type, in particular alkylbenzene sulfonate, fatty alkyl sulfate, fatty alkyl ether sulfate, alkyl and/or dialkyl sulfosuccinate, sulfo fatty acid esters, and/or sulfo fatty acid disalts, in particular in an amount in the range of 2% by weight to 25% by weight and particularly preferably of 5% by weight to 15% by weight. The anionic surfactant is preferably selected from alkylbenzene sulfonates, alkyl or alkenyl sulfates, and/or alkyl or alkenyl ether sulfates, in which the alkyl or alkenyl group has 8 to 22, particularly 12 to 18 C atoms. These are typically not individual substances but cuts or mixtures. Preferred of these are those whose proportion of compounds with longer-chain groups in the range of 16 to 18 C atoms is above 20% by weight. Particularly preferable is the presence of the aforementioned combination of polymer essential to the invention and alkylbenzene sulfonate with linear C₇₋₁₅ alkyl groups, in particular linear C9-13 alkyl groups, in the agents.

A further embodiment of agents of this kind comprises the presence of a nonionic surfactant, selected from fatty alkyl polyglycosides, fatty alkyl polyalkoxylates, in particular -ethoxylates and/or -propoxylates, fatty acid polyhydroxyamides, and/or ethoxylation and/or propoxylation products of fatty alkylamines, vicinal diols, fatty acid alkyl esters, and/or fatty acid amides, and mixtures thereof, in particular in an amount in the range of 2% by weight to 25% by weight.

Possible nonionic surfactants include the alkoxylates, in particular the ethoxylates and/or propoxylates, of saturated or mono- to polyunsaturated linear or branched-chain alcohols having 10 to 22 C atoms, preferably 12 to 18 C atoms. The degree of alkoxylation of the alcohols in this case is usually between 1 and 20, preferably between 3 and 10. They can be prepared in known fashion by reacting the corresponding alcohols with the corresponding alkylene oxides. The derivatives of fatty alcohols are particularly suitable, although their branched-chain isomers, in particular so-called oxo alcohols, may also be used for preparing usable alkoxylates. Accordingly, the alkoxylates, in particular the ethoxylates, of primary alcohols having linear, in particular dodecyl, tetradecyl, hexadecyl, or octadecyl groups, and mixtures thereof are usable. In addition, appropriate alkoxylation products of alkylamines, vicinal diols, and carboxylic acid amides which correspond to the aforesaid alcohols with regard to the alkyl portion are also usable. Moreover, the ethylene oxide and/or propylene oxide insertion products of fatty acid alkyl esters and fatty acid polyhydroxyamides are suitable. So-called alkyl polyglycosides which are suitable for incorporation into the products of the invention are compounds of the general formula (G)n-OR¹², in which R¹² denotes an alkyl or alkenyl group having 8 to 22 C atoms, G a glycose unit, and n a number between 1 and 10. The glycoside component (G)n refers to oligomers or polymers of naturally occurring aldose or ketose monomers, which include in particular glucose, mannose, fructose, galactose, talose, gulose, altrose, allose, idose, ribose, arabinose, xylose, and lyxose. The oligomers made up of glycosidically linked monomers of this kind are characterized not only by the type but also by the number of sugars they contain, the so-called degree of oligomerization. The degree of oligomerization n as a variable to be determined analytically generally assumes fractional numerical values; it has values between 1 and 10, and for the preferably used glycosides, a value less than 1.5, in particular between 1.2 and 1.4. Glucose is a preferred monomer unit because it is readily available. The alkyl or alkenyl portion R¹² of the glycosides preferably likewise derives from readily available derivatives of renewable raw materials, in particular from fatty alcohols, although the branched-chain isomers thereof, in particular so-called oxo alcohols, may also be used for preparing usable glycosides. In particular the primary alcohols having linear octyl, decyl, dodecyl, tetradecyl, hexadecyl, or octadecyl groups, and mixtures thereof are therefore usable. Particularly preferred alkyl glycosides contain a coconut fatty alkyl group, i.e., mixtures with substantially R¹²=dodecyl and R¹²=tetradecyl.

The nonionic surfactant is present in agents that contain an active substance used according to the invention or are used in the context of the use of the invention, preferably in amounts of 1% by weight to 30% by weight, particularly of 1% by weight to 25% by weight; amounts in the upper part of this range are more likely to be found in liquid detergents and particulate detergents preferably are more likely to contain smaller amounts of up to 5% by weight.

The agents can contain preferably synthetic anionic surfactants of the sulfate or sulfonate type, instead of or in addition to other surfactants. Alkyl and/or alkenyl sulfates having 8 to 22 C atoms, which carry an alkali-, ammonium-, or alkyl-, or hydroxyalkyl-substituted ammonium ion as a counter-cation, can be mentioned as synthetic anionic surfactants especially suitable for use in agents of this kind, apart from the aforementioned alkylbenzene sulfonates. Preferred are the derivatives of fatty alcohols having particularly 12 to 18 C atoms and the branched-chain analogues thereof, the so-called oxo alcohols. The alkyl and alkenyl sulfates can be prepared in a known manner by reacting the corresponding alcohol component with a typical sulfating reagent, particularly sulfur trioxide or chlorosulfonic acid, and subsequent neutralization with alkali-, ammonium-, or alkyl- or hydroxyalkyl-substituted ammonium bases. The sulfate-type surfactants that can be used also include the sulfated alkoxylation products of the aforesaid alcohols, the so-called ether sulfates. Such ether sulfates preferably contain 2 to 30, in particular 4 to 10 ethylene glycol groups per molecule. Suitable anionic surfactants of the sulfonate type include α-sulfo esters which are obtainable by reacting fatty acid esters with sulfur trioxide and subsequent neutralization, in particular the sulfonation products deriving from fatty acids having 8 to 22 C atoms, preferably 12 to 18 C atoms, and linear alcohols having 1 to 6 C atoms, preferably 1 to 4 C atoms, and the sulfo fatty acids resulting therefrom by formal saponification. Preferred anionic surfactants also include the salts of sulfosuccinic acid esters, which are also called alkyl sulfosuccinates or dialkylsulfosuccinates, and are the monoesters or diesters of sulfosuccinic acid with alcohols, preferably fatty alcohols and in particular ethoxylated fatty alcohols. Preferred sulfosuccinates contain C₈ to C₁₈ fatty alcohol groups or mixtures thereof. Particularly preferred sulfosuccinates contain an ethoxylated fatty alcohol group, which in itself represents a nonionic surfactant. In this case, sulfosuccinates whose fatty alcohol groups derive from ethoxylated fatty alcohols with a narrow homolog distribution are again particularly preferred.

Soaps are appropriate as further optional surfactant-type ingredients; saturated fatty acid soaps such as the salts of lauric acid, myristic acid, palmitic acid, or stearic acid, and soaps derived from natural fatty acid mixtures, for example, coconut, palm kernel, or tallow fatty acids, are suitable. Preferred in particular are soap mixtures that are made up of 50% by weight to 100% by weight of saturated C₁₂-C₁₈ fatty acid soaps and up to 50% by weight of oleic acid soap. Soap is contained preferably in amounts of 0.1% by weight to 5% by weight. Liquid agents in particular that contain a polymer used according to the invention can however also contain higher soap amounts of generally up to 20% by weight.

If desired, the agents can also contain betaine surfactants and/or cationic surfactants, which, if present, are used preferably in amounts of 0.5% by weight to 7% by weight. Among these, the esterquats discussed below are particularly preferred.

The products can contain, if desired, peroxygen-based bleaching agents, in particular in amounts in the range of 5% by weight to 70% by weight, and optionally, bleach activators, in particular in amounts in the range of 2% by weight to 10% by weight. Possible bleaching agents are preferably the peroxygen compounds generally used in detergents such as percarboxylic acids, for example, diperdodecanedioic acid or phthaloylaminoperoxycaproic acid, hydrogen peroxide, alkali perborate, which may be present as a tetrahydrate or monohydrate, percarbonate, perpyrophosphate, and persilicate, which are usually present as alkali salts, particularly as sodium salts. Bleaching agents of this kind are present in detergents, containing an active substance used according to the invention, preferably in amounts up to 25% by weight, particularly up to 15% by weight, and particularly preferably of 5% by weight to 15% by weight, based in each case on the total agent, percarbonate being used in particular. The optionally present bleach activator component comprises the usually employed N- or O-acyl compounds, for example, polyacylated alkylenediamines, particularly tetraacetylethylenediamine, acylated glycolurils, particularly tetraacetylglycoluril, N-acylated hydantoins, hydrazides, triazoles, urazoles, diketopiperazines, sulfurylamides, and cyanurates, in addition, carboxylic anhydrides, particularly phthalic anhydride, carboxylic acid esters, particularly sodium isononanoyl phenolsulfonate, and acylated sugar derivatives, particularly pentaacetyl glucose, and cationic nitrile derivatives such as trimethylammonium acetonitrile salts. In order to prevent interaction with the per-compounds during storage, the bleach activators can be coated with coating substances and/or granulated in known fashion; tetraacetylethylenediamine granulated with the aid of carboxymethylcellulose and with average particle sizes of 0.01 mm to 0.8 mm, granulated 1,5-diacetyl-2,4-dioxohexahydro-1,3,5-triazine, and/or trialkylammonium acetonitrile formulated in particle form are particularly preferred. Detergents contain bleach activators of this kind preferably in amounts up to 8% by weight, particularly of 2% by weight to 6% by weight, based in each case on the total agent.

In a further embodiment, the agent contains water-soluble and/or water-insoluble builders, selected in particular from alkali aluminosilicate, crystalline alkali silicate having a modulus greater than 1, monomeric polycarboxylate, polymeric polycarboxylate, and mixtures thereof, particularly in amounts in the range of 2.5% by weight to 60% by weight.

The agent contains preferably 20% by weight to 55% by weight of water-soluble and/or water-insoluble, organic and/or inorganic builders. Water-soluble organic builder substances include in particular those from the class of polycarboxylic acids, in particular citric acid and sugar acids, as well as polymeric (poly)carboxylic acids, in particular polycarboxylates obtainable by oxidation of polysaccharides, polymeric acrylic acids, methacrylic acids, maleic acids, and mixed polymers thereof, which can also contain, polymerized into them, small portions of polymerizable substances having no carboxylic acid functionality. The relative molecular mass of the homopolymers of unsaturated carboxylic acids is generally between 5000 g/mol and 200,000 g/mol, and that of the copolymers between 2000 g/mol and 200,000 g/mol, preferably 50,000 g/mol to 120,000 g/mol, based on free acid. An especially preferred acrylic acid/maleic acid copolymer has a relative molecular mass of 50,000 g/mol to 100,000 g/mol. Suitable, albeit less preferred, compounds of this class are copolymers of acrylic acid or methacrylic acid with vinyl ethers, such as vinyl methyl ethers, vinyl esters, ethylene, propylene, and styrene, the acid fraction of which amounts to at least 50% by weight. Terpolymers containing as monomers two carboxylic acids and/or the salts thereof and, as a third monomer, vinyl alcohol and/or a vinyl alcohol derivative or a carbohydrate may also be used as water-soluble organic builder substances. The first acid monomer or the salt thereof is derived from a monoethylenically unsaturated C₃-C₈ carboxylic acid and preferably from a C₃-C₄ monocarboxylic acid, in particular from (meth)acrylic acid. The second acid monomer or the salt thereof may be a derivative of a C₄-C₈ dicarboxylic acid, maleic acid being particularly preferred. The third monomer unit in this case is formed by vinyl alcohol and/or preferably by an esterified vinyl alcohol. Vinyl alcohol derivatives are preferred in particular that represent an ester of short-chain carboxylic acids, for example, of C₁-C₄ carboxylic acids, with vinyl alcohol. Preferred terpolymers in this case contain 60% by weight to 95% by weight, particularly 70% by weight to 90% by weight of (meth)acrylic acid and/or (meth)acrylate, particularly preferably acrylic acid and/or acrylate, and maleic acid and/or maleate, and 5% by weight to 40% by weight, preferably 10% by weight to 30% by weight of vinyl alcohol and/or vinyl acetate. Very particularly preferred in this case are terpolymers in which the weight ratio of (meth)acrylic acid and/or (meth)acrylate to maleic acid and/or maleate is between 1:1 and 4:1, preferably between 2:1 and 3:1, and particularly 2:1 and 2.5:1. In this case, both the amounts and weight ratios are based on the acids. The second acidic monomer or salt thereof can also be a derivative of an allylsulfonic acid, which is substituted in the 2-position with an alkyl group, preferably with a C₁-C₄ alkyl group, or an aromatic group, derived preferably from benzene or benzene derivatives. Preferred terpolymers in this case contain 40% by weight to 60% by weight, particularly 45 to 55% by weight of (meth)acrylic acid and/or (meth)acrylate, particularly preferably acrylic acid and/or acrylate, 10% by weight to 30% by weight, preferably 15% by weight to 25% by weight of methallylsulfonic acid and/or methallyl sulfonate, and as the third monomer 15% by weight to 40% by weight, preferably 20% by weight to 40% by weight of a carbohydrate. Said carbohydrate in this case can be, for example, a mono-, di-, oligo-, or polysaccharide, mono-, di-, or oligosaccharides being preferred and sucrose being particularly preferred. Predetermined breaking points, which are responsible for the good biodegradability of the polymer, are presumably incorporated into the polymer by the use of the third monomer. These terpolymers generally have a relative molecular mass between 1000 g/mol and 200,000 g/mol, preferably between 2000 g/mol and 50,000 g/mol, and particularly between 3000 g/mol and 10,000 g/mol. They can be used in the form of aqueous solutions, preferably in the form of 30 to 50% by weight aqueous solutions, particularly for the production of liquid products. All the cited polycarboxylic acids are generally used in the form of their water-soluble salts, in particular their alkali salts.

Organic builder substances of this kind are preferably contained in amounts of up to 40% by weight, in particular up to 25% by weight, and particularly preferably of 1% by weight to 5% by weight. Amounts close to the cited upper limit are preferably used in paste-like or liquid, in particular aqueous, detergents.

Crystalline or amorphous alkali aluminosilicates in particular are used as water-insoluble, water-dispersible inorganic builder materials in amounts of up to 50% by weight, preferably not above 40% by weight, and in liquid agents particularly of 1% by weight to 5% by weight. Among these, the crystalline aluminosilicates of detergent quality, particularly zeolite NaA and optionally NaX, are preferred. Amounts close to the cited upper limit are preferably used in solid, particulate agents. Suitable aluminosilicates have in particular no particles with a particle size greater than 30 μm and preferably consist of at least 80% by weight of particles with a size of less than 10 μm. Their calcium-binding capacity is in the range of 100 to 200 mg of CaO per gram. Suitable substitutes or partial substitutes for the aforesaid aluminosilicate are crystalline alkali silicates, which may be present alone or in a mixture with amorphous silicates. Alkali silicates that can be used as builders in the agents preferably have a molar ratio of alkali oxide to SiO₂ of less than 0.95, particularly of 1:1.1 to 1:12, and can be amorphous or crystalline. Preferred alkali silicates are sodium silicates, particularly amorphous sodium silicates, with a molar ratio of Na₂O:SiO₂ of 1:2 to 1:2.8. Amorphous alkali silicates of this kind are commercially available under the name Portil®, for example. Within the context of production, those having an Na₂O:SiO₂ molar ratio of 1:1.9 to 1:2.8 are preferably added as a solid, and not in the form of a solution. Crystalline phyllosilicates of the general formula Na₂SiₓO₂ₓ₊₁.yH₂O, in which the so-called modulus x is a number from 1.9 to 4 and y is a number from 0 to 20, with preferred values for x being 2, 3, or 4, are preferably used as crystalline silicates, which can be present alone or in a mixture with amorphous silicates. Crystalline phyllosilicates, which are included in this general formula, are described, for example, in the European patent application EP 0164514. Preferred crystalline phyllosilicates are those in which x assumes the values 2 or 3 in the aforesaid general formula. Both β- and δ-sodium disilicates (Na₂Si₂O₅.yH₂O) are preferred in particular. Practically anhydrous crystalline alkali silicates, prepared from amorphous alkali silicates and having the aforementioned general formula, in which x denotes a number from 1.9 to 2.1, can also be used in agents containing an active substance to be used according to the invention. In a further preferred embodiment of the agents of the invention, a crystalline sodium phyllosilicate with a modulus of 2 to 3 is used, such as can be prepared from sand and soda. Crystalline sodium silicates having a modulus in the range of 1.9 to 3.5 are used in another preferred embodiment of detergents, containing an active substance used according to the invention. Their alkali silicate content is preferably 1% by weight to 50% by weight and particularly 5% by weight to 35% by weight, based on the anhydrous active substance. If alkali aluminosilicate, particularly zeolite, is also present as an additional builder substance, the alkali silicate content is preferably 1% by weight to 15% by weight and particularly 2% by weight to 8% by weight, based on anhydrous active substance. The weight ratio of aluminosilicate to silicate, based in each case on anhydrous active substances, is then preferably 4:1 to 10:1. In agents, containing both amorphous and crystalline alkali silicates, the weight ratio of amorphous alkali silicate to crystalline alkali silicate is preferably 1:2 to 2:1 and particularly 1:1 to 2:1.

In addition to the aforesaid inorganic builders, other water-soluble or water-insoluble inorganic substances can be present in the agents that contain an active substance to be used according to the invention, are used together with it, or be used in the method of the invention. Suitable in this connection are alkali carbonates, alkali hydrogen carbonates, and alkali sulfates and mixtures thereof. An additional inorganic material of this kind can be present in amounts up to 70% by weight.

In addition, the agents may contain other components customary in detergents or cleaning products. These optional components include in particular enzymes, enzyme stabilizers, complexing agents for heavy metals, for example, aminopolycarboxylic acids, aminohydroxypolycarboxylic acids, polyphosphonic acids, and/or aminopolyphosphonic acids, foam inhibitors, for example, organopolysiloxanes or paraffins, solvents, and optical brighteners, for example, stilbenedisulfonic acid derivatives. Agents that contain an active substance used according to the invention preferably contain up to 1% by weight, particularly 0.01% by weight to 0.5% by weight of optical brighteners, in particular compounds from the class of substituted 4,4′-bis(2,4,6-triamino-s-triazinyl)stilbene-2,2′-disulfonic acids, up to 5% by weight, in particular 0.1% by weight to 2% by weight, of complexing agents for heavy metals, in particular aminoalkylene phosphonic acids and salts thereof, and up to 2% by weight, in particular 0.1% by weight to 1% by weight of foam inhibitors, the aforesaid percentages by weight referring in each case to the total agent.

Solvents, which can be used in particular in liquid agents, are, apart from water, preferably those that are water-miscible. These include the lower alcohols, for example, ethanol, propanol, isopropanol, and the isomeric butanols, glycerol, lower glycols, for example, ethylene glycol and propylene glycol, and the ethers derivable from the aforesaid compound classes. Liquid agents of this kind generally contain the active substances, used according to the invention, dissolved or in suspended form.

Optionally present enzymes are preferably selected from the group comprising protease, amylase, lipase, cellulase, hemicellulase, oxidase, peroxidase, pectinase, or mixtures thereof. Suitable primarily is the protease obtained from microorganisms, such as bacteria or fungi. It can be obtained in a known fashion by fermentation processes from suitable microorganisms. Proteases are commercially available, for example, under the names BLAP®, Savinase®, Esperase®, Maxatase®, Optimase®, Alcalase®, Durazym®, or Maxapem®. The usable lipases can be obtained, for example, from Humicola lanuginosa, from Bacillus species, from Pseudomonas species, from Fusarium species, from Rhizopus species, or from Aspergillus species. Suitable lipases are commercially available, for example, under the names Lipolase®, Lipozym®, Lipomax®, Lipex®, Amano® Lipase, Toyo-Jozo® Lipase, Meito® Lipase, and Diosynth® Lipase. Suitable amylases are commercially available, for example, under the names Maxamyl®, Termamyl®, Duramyl®, and Purafect® OxAm. The usable cellulases can be an enzyme which is obtainable from bacteria or fungi and has a pH optimum preferably in the weakly acidic to weakly alkaline range of 6 to 9.5. Cellulases of this kind are commercially available under the names Celluzyme®, Carezyme®, and Ecostone®. Suitable pectinases are obtainable, for example, under the names Gamanase®, Pektinex AR®, XPect® or Pectaway® from Novozymes, under the name Rohapect UIF®, Rohapect TPL®, Rohapect PTE100®, Rohapect MPE®, Rohapect MA plus HC, Rohapect DA12L®, Rohapect Rohapect B1L® from AB Enzymes, and under the name Pyrolase® from Diversa Corp., San Diego, Calif., USA.

Customary enzyme stabilizers, optionally present especially in liquid products, include amino alcohols, for example, mono-, di-, and triethanolamine and -propanolamine and mixtures thereof, lower carboxylic acids, boric acid, alkali borates, boric acid/carboxylic acid combinations, boric acid esters, boronic acid derivatives, calcium salts, for example, a Ca/formic acid combination, magnesium salts, and/or sulfur-containing reducing agents.

Suitable foam inhibitors include long-chain soaps, in particular behenic soap, fatty acid amides, paraffins, waxes, microcrystalline waxes, organopolysiloxanes, and mixtures thereof, which may contain moreover microfine, optionally silanized or otherwise hydrophobized silicic acid. For use in particulate agents, foam inhibitors of this kind are preferably bound to granular, water-soluble carrier substances.

The known polyester-active soil-release polymers, which may be used in addition to the active substances essential to the invention, include copolyesters of dicarboxylic acids, for example, adipic acid, phthalic acid, or terephthalic acid, and diols, for example, ethylene glycol or propylene glycol, and polydiols, for example, polyethylene glycol or polypropylene glycol. The preferably used soil-release polyesters include compounds that are obtainable formally by esterification of two monomer parts, wherein the first monomer is a dicarboxylic acid HOOC-Ph-COOH, and the second monomer a diol HO—(CHR¹¹—) aOH, which may also be present as a polymer diol H—(O—(CHR¹¹—)ₐ)_{b}OH. Ph therein denotes an o-, m-, or p-phenylene group which may bear 1 to 4 substituents selected from alkyl groups having 1 to 22 C atoms, sulfonic acid groups, carboxyl groups, and mixtures thereof, R¹¹ denotes hydrogen, an alkyl group having 1 to 22 C atoms, and mixtures thereof, a is a number from 2 to 6, and b a number from 1 to 300. The polyesters obtainable therefrom preferably contain both monomer diol units —O—(CHR¹¹—)ₐO— and polymer diol units —O—(CHR¹¹—)ₐ)_{b}O—. The molar ratio of monomer diol units to polymer diol units is preferably 100:1 to 1:100, particularly 10:1 to 1:10. The degree of polymerization b in the polymer diol units is preferably in the range of 4 to 200, in particular 12 to 140. The molecular weight or average molecular weight or the maximum of the molecular weight distribution of preferred soil-release polyesters is in the range of 250 g/mol to 100,000 g/mol, in particular 500 g/mol to 50,000 g/mol. The acid forming the basis for the Ph group is preferably selected from terephthalic acid, isophthalic acid, phthalic acid, trimellitic acid, mellitic acid, the isomers of sulfophthalic acid, sulfoisophthalic acid, and sulfoterephthalic acid, and mixtures thereof. Provided the acid groups thereof are not part of the ester bonds in the polymer, they are preferably present in the form of a salt, particularly as an alkali or ammonium salt. Among these, the sodium and potassium salts are particularly preferred. If desired, instead of the HOOC-Ph-COOH monomer, small portions, in particular no more than 10 mol %, based on the portion of Ph having the meaning stated above, of other acids which have at least two carboxyl groups may be contained in the soil-release polyester. These include, for example, alkylene and alkenylene dicarboxylic acids such as malonic acid, succinic acid, fumaric acid, maleic acid, glutaric acid, adipic acid, pimelic acid, suberic acid, azelaic acid, and sebacic acid. The preferred diols HO—(CHR¹¹—)ₐ—H include those in which R¹¹ is hydrogen and a is a number from 2 to 6, and those in which a has the value 2 and R¹¹ is selected from among hydrogen and alkyl groups having 1 to 10, in particular 1 to 3 C atoms. Of the last-mentioned diols, those of formula HO—CH₂—CHR¹¹—OH, in which has the aforesaid meaning, are particularly preferred. Examples of diol components are ethylene glycol, 1,2-propylene glycol, 1,3-propylene glycol, 1,4-butanediol, 1,5-pentanediol, 1,6-hexanediol, 1,8-octanediol, 1,2-decanediol, 1,2-dodecanediol, and neopentyl glycol. Among the polymeric diols, polyethylene glycol having an average molar mass in the range of 1000 g/mol to 6000 g/mol, is particularly preferred.

If desired, these polyesters with the composition described above may also be end-capped, alkyl groups having 1 to 22 C atoms and esters of monocarboxylic acids being suitable as end groups. The end groups bound via ester bonds can be based on alkyl, alkenyl, and aryl monocarboxylic acids having 5 to 32 C atoms, particularly 5 to 18 C atoms. These include valeric acid, caproic acid, enanthic acid, caprylic acid, pelargonic acid, capric acid, undecanoic acid, undecenoic acid, lauric acid, lauroleic acid, tridecanoic acid, myristic acid, myristoleic acid, pentadecanoic acid, palmitic acid, stearic acid, petroselic acid, petroselaidic acid, oleic acid, linoleic acid, linolaidic acid, linolenic acid, eleostearic acid, arachidic acid, gadoleic acid, arachidonic acid, behenic acid, erucic acid, brassidic acid, clupanodonic acid, lignoceric acid, cerotic acid, melissic acid, and benzoic acid, which can carry 1 to 5 substituents having a total of up to 25 C atoms, in particular 1 to 12 C atoms, for example, tert-butylbenzoic acid. The end groups can also be based on hydroxymonocarboxylic acids having 5 to 22 C atoms, which include, for example, hydroxyvaleric acid, hydroxycaproic acid, ricinoleic acid, its hydrogenation product hydroxystearic acid, and o-, m-, and p-hydroxybenzoic acid. The hydroxymonocarboxylic acids can in turn be connected to one another via their hydroxyl group and their carboxyl group, and thus can be present in multiple fashion in an end group. The number of hydroxymonocarboxylic acid units per end group, i.e., their degree of oligomerization, is preferably in the range of 1 to 50, in particular, of 1 to 10. In a preferred embodiment of the invention, polymers of ethylene terephthalate and polyethylene oxide terephthalate, in which the polyethylene glycol units have molar weights of 750 g/mol to 5000 g/mol and the molar ratio of ethylene terephthalate to polyethylene oxide terephthalate is 50:50 to 90:10, are used in combination with an active substance essential to the invention.

The soil-release polymers are preferably water-soluble, wherein the term “water-soluble” is to be understood to mean a solubility of at least 0.01 g, preferably at least 0.1 g of the polymer per liter of water at room temperature and pH 8. Preferably employed polymers under these conditions, however, have a solubility of at least 1 g per liter, particularly at least 10 g per liter.

The production of solid agents of the invention presents no difficulties and can occur in a known manner, for example, by spray-drying or granulation, wherein enzymes and possibly other thermally sensitive ingredients such as, for example, bleaching agents are added separately later, if desired. A method having an extrusion step is preferable for producing agents of the invention with an elevated bulk weight, particularly in the range of 650 g/L to 950 g/L.

To produce agents of the invention in tablet form, which may be monophasic or multiphasic, single-colored or multicolored, and in particular may consist of one layer or of many layers, particularly of two layers, it is preferred to proceed such that all ingredients, optionally for each layer, are mixed together in a mixer and the mixture is compressed by means of conventional tablet presses, for example, eccentric presses or rotary presses, with compressive forces in the range of approximately 50 to 100 kN, preferably at 60 to 70 kN. In particular in the case of multilayer tablets, it may be advantageous for at least one layer to be precompressed. This is preferably carried out at compressive forces between 5 and 20 kN, in particular at 10 to 15 kN. In this manner, tablets that are break-resistant and yet dissolve sufficiently rapidly under conditions of use and with breaking and bending strengths usually from 100 to 200 N, but preferably of above 150 N are easily obtained in this way. A tablet produced in this manner preferably has a weight of 10 g to 50 g, in particular of 15 g to 40 g. The shape of the tablets is arbitrary and may be round, oval, or polygonal, intermediate shapes also being possible. Corners and edges are advantageously rounded. Round tablets preferably have a diameter from 30 mm to 40 mm. In particular, the size of polygonal or cuboidal tablets, which are predominantly introduced by means of the dispenser, for example, of a dishwasher, depends on the geometry and volume of said dispenser. Preferred embodiments have, for example, a base area of (20 to 30 mm)×(34 to 40 mm), in particular of 26×36 mm or of 24×38 mm.

Liquid or pasty products of the invention in the form of solutions containing conventional solvents, in particular water, are generally produced by simply mixing the ingredients, which may be introduced into an automatic mixer in bulk or as a solution.

In a preferred embodiment, an agent into which the active substance to be used according to the invention is to be incorporated is liquid and contains 1% by weight to 15% by weight, particularly 2% by weight to 10% by weight of nonionic surfactant, 2% by weight to 30% by weight, particularly 5% by weight to 20% by weight of synthetic anionic surfactant, up to 15% by weight, particularly 2% by weight to 12.5% by weight of soap, 0.5% by weight to 5% by weight, particularly 1% by weight to 4% by weight of organic builder, particularly polycarboxylate such as citrate, up to 1.5% by weight, particularly 0.1% by weight to 1% by weight of complexing agent for heavy metals, such as phosphonate, and water and/or a water-miscible solvent, apart from optionally present enzyme, enzyme stabilizer, dye and/or scent.

In a further preferred embodiment, an agent into which an active substance to be used according to invention is incorporated, is particulate and contains up to 25% by weight, particularly 5% by weight to 20% by weight of bleaching agent, particularly alkali percarbonate, up to 15% by weight, particularly 1% by weight to 10% by weight of bleach activator, 20% by weight to 55% by weight of inorganic builder, up to 10% by weight, particularly 2% by weight to 8% by weight of water-soluble organic builder, 10% by weight to 25% by weight of synthetic anionic surfactant, 1% by weight to 5% by weight of nonionic surfactant, and up to 25% by weight, particularly 0.1% by weight to 25% by weight of inorganic salts, particularly alkali carbonate and/or alkali hydrogen carbonate.

### Examples

### Example 1: Preparation of poly(3-(N,N-diallyl-N-methylammonio-)N-propane-1-sulfonate-co-N-vinylpyrrolidone)

a) 6.8 g of 3-(N,N-diallyl-N-methylammonio-)N-propane-1-sulfonate, 3.2 g of N-vinyl-2-pyrrolidone, and 410 mg of azobis-[N-(2-carboxyethyl)-2-methylpropionamidine] were introduced with 9.8 mL of water and 4.2 mL of ethanol into Schlenk flasks; oxygen was removed by 30 minutes of rinsing with nitrogen. Next, the reaction mixture was stirred for 24 h at 65° C. The polymer V1 was isolated after dilution with water by freeze-drying.
b) 6.8 g of 3-(N,N-diallyl-N-methylammonio-)N-propane-1-sulfonate, 3.2 g of N-vinyl-2-pyrrolidone, and 102 mg of azobis-[N-(2-carboxyethyl)-2-methylpropionamidine] were introduced with 9.8 mL of water and 4.2 mL of ethanol into Schlenk flasks; oxygen was removed by 30 minutes of rinsing with nitrogen. Next, the reaction mixture was stirred for 24 h at 65° C. The polymer V2 was isolated after dilution with water by freeze-drying.
c) 3.5 g of 3-(N,N-diallyl-N-methylammonio-)N-propane-1-sulfonate, 6.5 g of N-vinyl-2-pyrrolidone, and 506 mg of azobis-[N-(2-carboxyethyl)-2-methylpropionamidine] were introduced with 9.8 mL of water and 4.2 mL of ethanol into Schlenk flasks; oxygen was removed by 30 minutes of rinsing with nitrogen. Next, the reaction mixture was stirred for 24 h at 65° C. The polymer V3 was isolated after dilution with water by freeze-drying.
d) 3.5 g of 3-(N,N-diallyl-N-methylammonio-)N-propane-1-sulfonate, 6.5 g of N-vinyl-2-pyrrolidone, and 126 mg of azobis-[N-(2-carboxyethyl)-2-methylpropionamidine] were introduced with 9.8 mL of water and 4.2 mL of ethanol into Schlenk flasks; oxygen was removed by 30 minutes of rinsing with nitrogen. Next, the reaction mixture was stirred for 24 h at 65° C. The polymer V4 was isolated after dilution with water by freeze-drying.

Among the thus prepared variants of poly(3-(N,N-diallyl-N-methylammonio-) N-propane-1-sulfonate-co-N-vinylpyrrolidone) with the molar ratios, given in Table 1, of 3-(N,N-diallyl-N-methylammonio-)N-propane-1-sulfonate to N-vinyl-2-pyrrolidone, the polymers V1 and V3 had a lower molar mass than the polymers V2 and V4.

| Polymer | Molar ratio |
|---|---|
| V1 | 50:50 |
| V2 | 50:50 |
| V3 | 20:80 |
| V4 | 20:80 |

### Example 2

TABLE 2
Detergent compositions (quantities are given in % by weight)

| | A | B | C | D | E | F | G | H |
|---|---|---|---|---|---|---|---|---|
| C₉₋₁₃ alkylbenzene | 9 | 10 | 6 | 7 | 5 | 15 | 15 | 9 |
| sulfonate, Na-salt | | | | | | | | |
| C₁₂₋₁₈ fatty alcohol | 8 | 9 | 6 | 7 | 5 | 6 | 11 | 10 |
| with 7 EO | | | | | | | | |
| C₁₂₋₁₄ fatty alcohol | — | — | 8 | 7 | 10 | 2 | 2 | 5 |
| sulfate with 2 EO | | | | | | | | |
| C₁₂₋₁₈ fatty acids, | 4 | 3 | 3 | 3 | 4 | 2 | 4 | 7 |
| Na salt | | | | | | | | |
| Citric acid | 2 | 3 | 3 | 2 | 2 | 2 | 2 | 3 |
| Sodium hydroxide, | 3 | 3 | 2 | 3 | 3 | 3 | 3 | 4 |
| 50% | | | | | | | | |
| Boric acid | 1 | 1 | 1 | 1 | 1 | 1 | 1 | 1 |
| Enzymes (amylase, | + | + | + | + | + | + | + | + |
| protease, cellulase) | | | | | | | | |
| Perfume | 1 | 0.5 | 0.5 | 1 | 1 | 1 | 1 | 1 |
| Glycerol | 3 | 2 | 2 | 2 | 2 | — | — | 2 |
| Propanediol | — | — | — | — | — | 5 | 5 | — |
| Ethanol | 1.5 | 1.5 | 1.5 | 1.5 | 1.5 | 1.5 | 1.5 | 5 |
| PVA/maleic acid | 0.1 | | 0.1 | — | — | — | — | — |
| copolymer | | | | | | | | |
| Optical brightener | — | 0.1 | — | 0.1 | 0.2 | 0.2 | 0.2 | 0.2 |
| Alkylaminophosphonic | 0.5 | 0.5 | 0.5 | 0.5 | 0.5 | 0.5 | 0.5 | 0.5 |
| acid | | | | | | | | |
| Polymer essential to | 2 | 2 | 2 | 2 | 2 | 2 | 2 | 2 |
| the invention | | | | | | | | |

| | |
|---|---|
| Water | to 100 |

### Example 3: Washing Tests

Textiles made of cotton provided with standardized stains (A: C-02, rust/olive oil; B: 10D, pigment/sebum; C: C-03, chocolate milk/rust; D: 10WB, blueberry juice; E: 10BB, blackberry juice; obtainable from the Center for Testmaterials BV and wfk Cleaning Technology Institute e.V.) were washed for 1 hour at 25° C. with detergent C specified in Example 2 with in each case a polymer V1 to V4, prepared in Example 1, in a detergent dose of 4.2 g/L. After washing out with water and drying by hanging of the test textiles, the whiteness thereof was determined by spectrophotometry (Minolta® CR400-1). The differences of the reflectance values (in % in each case) for the similar use of the detergent with the otherwise same composition without the specified active substances as averages of 5 determinations are given in the following Table 3.

TABLE 3
Washing results (reflectance difference)

| Stain/polymer | V1 | V2 | V3 | V4 |
|---|---|---|---|---|
| A | 1.2 | 5.1 | 2.6 | 0.2 |
| B | n.d. | 2.3 | 2.4 | 3.3 |
| C | 2.2 | 2.0 | 3.1 | 2.8 |
| D | n.d. | n.d. | 2.9 | 2.9 |
| E | n.d. | n.d. | 2.2 | 2.5 |

n.d.: not determined

The detergents with the active substances to be used according to the invention showed a considerably better primary detergency than an agent with the otherwise same composition without said substances.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A method for removing stains from textiles comprising the step of introducing a detergent or cleaning product into an aqueous bath in a domestic washing machine, wherein the detergent or cleaning product comprises a polymer obtainable from the monomers N,N-diallyl-N—C₁₋₁₂-alkyl-ammonio-N—C₁₋₄-alkyl sulfonate and N-vinyl-2-pyrrolidone, and wherein the concentration of the polymer in the aqueous bath is in the range of 0.01 g/L to 0.5 g/L.

2. The method according to claim 1, wherein the detergent or cleaning product comprises from 0.1% by weight to 10% by weight of the polymer.

3. The method according to claim 1, wherein the detergent or cleaning product comprises a polymer comprising units originating from the monomer N,N-diallyl-N—C₁₋₁₂-alkyl-ammonio-N—C₁₋₄-alkyl sulfonate and units originating from the monomer N-vinyl-2-pyrrolidone and wherein the units are present in the polymer in weight ratios in the range of 1:99 to 99:1.

4. The method according to claim 1, wherein the detergent or cleaning product comprises a polymer comprising having an average molecular weight in the range of 1000 g/mol to 300,000 g/mol.

5. A method for removing stains from textiles comprising the step of introducing a detergent or cleaning product into an aqueous bath in a domestic washing machine, wherein the detergent or cleaning product comprises a polymer obtainable from the monomers N,N-diallyl-N—C₁₋₁₂-alkyl-ammonio-N—C₁₋₄-alkyl sulfonate and N-vinyl-2-pyrrolidone, and alkylbenzene sulfonate having linear C₇₋₁₅ alkyl groups.

6. The method according to claim 5, wherein the weight ratio of linear alkylbenzene sulfonate to the polymer is in the range of 20:1 to 1:1.
